(19) United States
(12) Patent Application Publication
(10) Pub. No.: US 2017/0094654 A1
(43) Pub. Date: Mar. 30, 2017

(54) SERVICE REQUEST, SCHEDULING REQUEST, AND ALLOCATION OF RADIO RESOURCES FOR SERVICE CONTEXTS

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/866,538

(22) Filed: Sep. 25, 2015

(51) Int. Cl. H04W 72/04

(52) U.S. Cl. CPC H04W 72/0413; H04W 72/048

(57) ABSTRACT

In one instance, a user equipment (UE) determines, at an application layer, an application activity that triggers a service request before data arrives at a buffer of the UE. In response to the determining, the UE may send, from a NAS layer (non-access stratum layer), the service request to a base station requesting one or more radio bearers for one or more service contexts when no radio bearer is assigned for the one or more service contexts. Alternatively, the UE may send a schedule request from a lower layer than the NAS layer when the radio bearer is already assigned before data arrives at the buffer of the UE.

### BACKGROUND

Field

Aspects of the present disclosure relate generally to wireless communication systems, and more particularly, to scheduling requests for service contexts and/or service requests for radio bearer establishment for the service contexts.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China employs TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method of wireless communication includes determining, at an application layer, an application activity that triggers a service request before data arrives at a buffer of a UE (user equipment). In response to the determining, The method also includes either sending, from a NAS layer (non-access stratum layer), the service request to a base station requesting at least one radio bearer for at least one service context when no radio bearer is assigned for the at least one service context or sending a schedule request from a lower layer than the NAS layer when the radio bearer is already assigned before data arrives at the buffer of the UE.

According to another aspect of the present disclosure, an apparatus for wireless communication includes means for determining, at an application layer, an application activity that triggers a service request before data arrives at a buffer of a UE (user equipment). The apparatus may also include means for sending, from a NAS layer (non-access stratum layer), the service request to a base station requesting at least one radio bearer (e.g., one or more) for at least one service context when no radio bearer is assigned for the one in response to the determining. The apparatus may also include means for sending a schedule request from a lower layer than the NAS layer when the radio bearer is already assigned before data arrives at the buffer of the UE in response to the determining.

Another aspect discloses an apparatus for wireless communication and includes a memory and at least one processor coupled to the memory. The processor(s) is configured to determine, at an application layer, an application activity that triggers a service request before data arrives at a buffer of a UE (user equipment). The processor(s) is also configured to send, from a NAS layer (non-access stratum layer), the service request to a base station requesting one or more radio bearers for one or more service contexts when no radio bearer is assigned for the one in response to the determining. The processor(s) is also configured to send a schedule request from a lower layer than the NAS layer when the radio bearer is already assigned before data arrives at the buffer of the UE in response to the determining.

Yet another aspect discloses a computer program product for wireless communications in a wireless network having a non-transitory computer-readable medium. The computer-readable medium has non-transitory program code recorded thereon which, when executed by the processor(s), causes the processor(s) to determine, at an application layer, an application activity that triggers a service request before data arrives at a buffer of a UE (user equipment). The program code also causes the processor(s) to send, from a NAS layer (non-access stratum layer), the service request to a base station requesting one or more radio bearers for one or more service contexts when no radio bearer is assigned for the one in response to the determining. The program code further causes the processor(s) to send a schedule request from a lower layer than the NAS layer when the radio bearer is already assigned before data arrives at the buffer of the UE in response to the determining.

According to one aspect of the present disclosure, a method for wireless communication includes determining whether a data activity relationship exists between a first service context and a second service context. The method also includes sending a service request for the first service context and the second service context to request radio bearers for both service contexts without receiving data associated with the second service context at a buffer of a UE (user equipment) when the data activity relationship exists. The method includes sending a schedule request for both the first service context and the second service context with radio bearer assignments without receiving data associated with the second service context at the buffer of the UE when the data activity relationship exists.

According to another aspect of the present disclosure, an apparatus for wireless communication includes means for determining whether a data activity relationship exists between a first service context and a second service context. The apparatus may also include means for sending a service request for the first service context and the second service context to request radio bearers for both service contexts without receiving data associated with the second service context at a buffer of a UE (user equipment) when the data activity relationship exists. The apparatus may also include means for sending a schedule request for both the first service context and the second service context with radio bearer assignments without receiving data associated with the second service context at the buffer of the UE when the data activity relationship exists.

Another aspect discloses an apparatus for wireless communication and includes a memory and one or more processors coupled to the memory. The processor(s) is configured to determine whether a data activity relationship exists between a first service context and a second service context. The processor(s) is also configured to send a service request for the first service context and the second service context to request radio bearers for both service contexts without receiving data associated with the second service context at a buffer of a UE (user equipment) when the data activity relationship exists. The processor(s) is also configured to send a schedule request for both the first service context and the second service context with radio bearer assignments without receiving data associated with the second service context at the buffer of the UE when the data activity relationship exists.

Yet another aspect discloses a computer program product for wireless communications in a wireless network having a non-transitory computer-readable medium. The computer-readable medium has non-transitory program code recorded thereon which, when executed by the processor(s), causes the processor(s) to determine whether a data activity relationship exists between a first service context and a second service context. The program code also causes the processor(s) to send a service request for the first service context and the second service context to request radio bearers for both service contexts without receiving data associated with the second service context at a buffer of a UE (user equipment) when the data activity relationship exists. The program code further causes the processor(s) to send a schedule request for both the first service context and the second service context with radio bearer assignments without receiving data associated with the second service context at the buffer of the UE when the data activity relationship exists.

According to one aspect of the present disclosure, a method for wireless communication includes receiving a service request for one or more radio bearers for a first service context. The method also includes determining whether a relationship exists between the first service context and a second service context based on a data activity relationship. The method also includes sending a single radio bearer setup for setting up a first radio bearer for the first service context and a second radio bearer for the second service context based on the determining.

According to another aspect of the present disclosure, an apparatus for wireless communication includes means for receiving a service request for one or more radio bearers for a first service context. The apparatus may also include means for determining whether a relationship exists between the first service context and a second service context based on a data activity relationship. The apparatus may also include means for sending a single radio bearer setup for setting up a first radio bearer for the first service context and a second radio bearer for the second service context based on the determining.

Another aspect discloses an apparatus for wireless communication and includes a memory and one or more processors coupled to the memory. The processor(s) is configured to receive a service request for one or more radio bearers for a first service context. The processor(s) is also configured to determine whether a relationship exists between the first service context and a second service context based on a data activity relationship. The processor(s) is also configured to send a single radio bearer setup for setting up a first radio bearer for the first service context and a second radio bearer for the second service context based on the determining.

Yet another aspect discloses a computer program product for wireless communications in a wireless network having a non-transitory computer-readable medium. The computer-readable medium has non-transitory program code recorded thereon which, when executed by the processor(s), causes the processor(s) to receive a service request for one or more radio bearers for a first service context. The program code also causes the processor(s) to determine whether a relationship exists between the first service context and a second service context based on a data activity relationship. The program code further causes the processor(s) to send a single radio bearer setup for setting up a first radio bearer for the first service context and a second radio bearer for the second service context based on the determining.

According to one aspect of the present disclosure, a method for wireless communication includes receiving a schedule request for a first service context. The method also includes determining a relationship exists between the first service context and a second service context based on a data activity relationship. The method also includes determining a grant size for the first service context and the second service context. The method further includes sending a grant for both the first service context and the second service context based on the determining of the relationship and the determining of the service context grant size.

According to another aspect of the present disclosure, an apparatus for wireless communication includes means for receiving a schedule request for a first service context. The apparatus may also include means for determining a relationship exists between the first service context and a second service context based on a data activity relationship. The apparatus may also include means for determining a grant size for the first service context and the second service context. The apparatus may also include means for sending a grant for both the first service context and the second service context based on the determining of the relationship and the determining of the service context grant size.

Another aspect discloses an apparatus for wireless communication and includes a memory and one or more processors coupled to the memory. The processor(s) is configured to receive a schedule request for a first service context. The processor(s) is also configured to determine a relationship exists between the first service context and a second service context based on a data activity relationship. The processor(s) is also configured to determine a grant size for the first service context and the second service context. The processor(s) is also configured to send a grant for both the first service context and the second service context based on the determining of the relationship and the determining of the service context grant size.

Yet another aspect discloses a computer program product for wireless communications in a wireless network having a non-transitory computer-readable medium. The computer-readable medium has non-transitory program code recorded thereon which, when executed by the processor(s), causes the processor(s) to receive a schedule request for a first service context. The program code also causes the processor(s) to determine a relationship exists between the first service context and a second service context based on a data activity relationship. The program code further causes the processor(s) to determine a grant size for the first service context and the second service context. The program code further causes the processor(s) to send a grant for both the first service context and the second service context based on the determining of the relationship and the determining of the service context grant size.

This has outlined, rather broadly, features of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify corresponding elements throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram conceptually illustrating an example of a base station in communication with a user equipment (UE) in a telecommunications system.

FIG. 5 is a conceptual diagram illustrating an example of a radio protocol architecture for a user plane and a control plane.

FIG. 6 is a flow diagram illustrating an example method for sending a service request for radio resources for a service context or a schedule request for the service context according to aspects of the present disclosure.

FIG. 7 is a flow diagram illustrating an example method at a user equipment according to aspects of the present disclosure.

FIG. 8 is a flow diagram illustrating an example method at a user equipment according to aspects of the present disclosure.

FIG. 9 is a flow diagram illustrating an example method at a base station according to aspects of the present disclosure.

FIG. 10 is a flow diagram illustrating an example method at a base station according to aspects of the present disclosure.

FIG. 11 is a diagram illustrating an example of a hardware implementation for an apparatus employing a processing system according to one aspect of the present disclosure.

FIG. 12 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

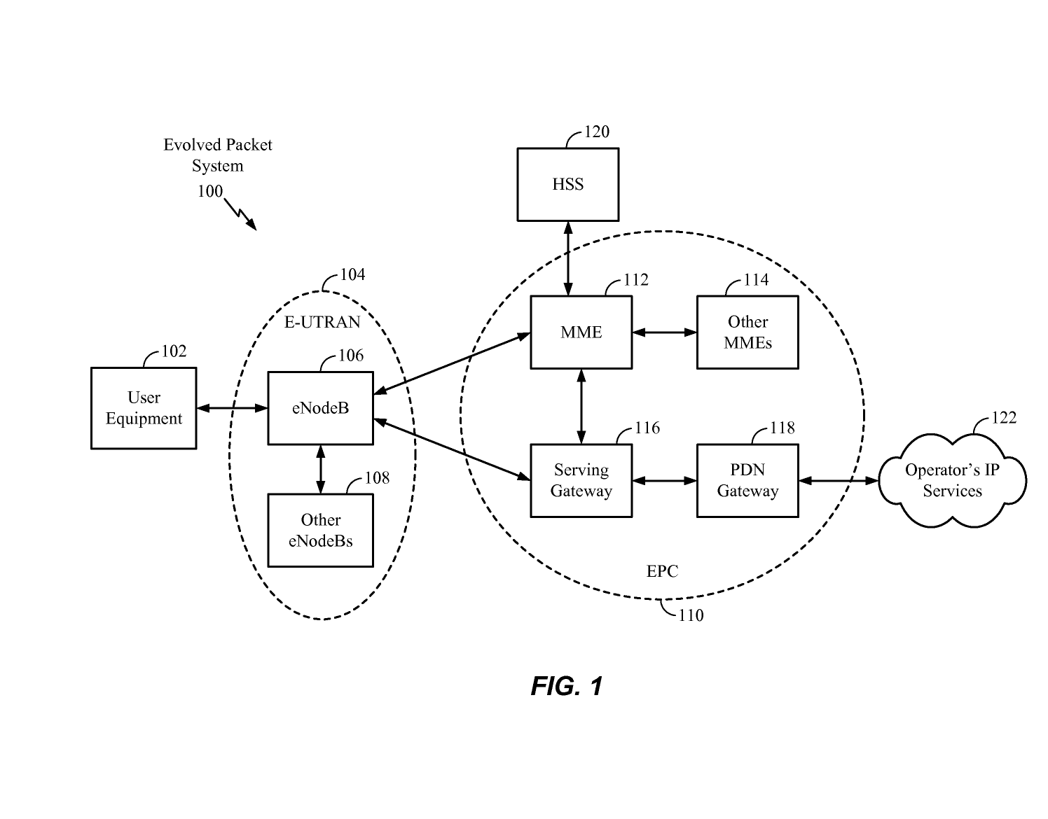

FIG. 1 is a diagram illustrating a network architecture 100 of a long-term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity, those entities/interfaces are not shown. As shown, the EPS 100 provides packet-switched services. As those skilled in the art will readily appreciate, however, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a tablet, a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an 51 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

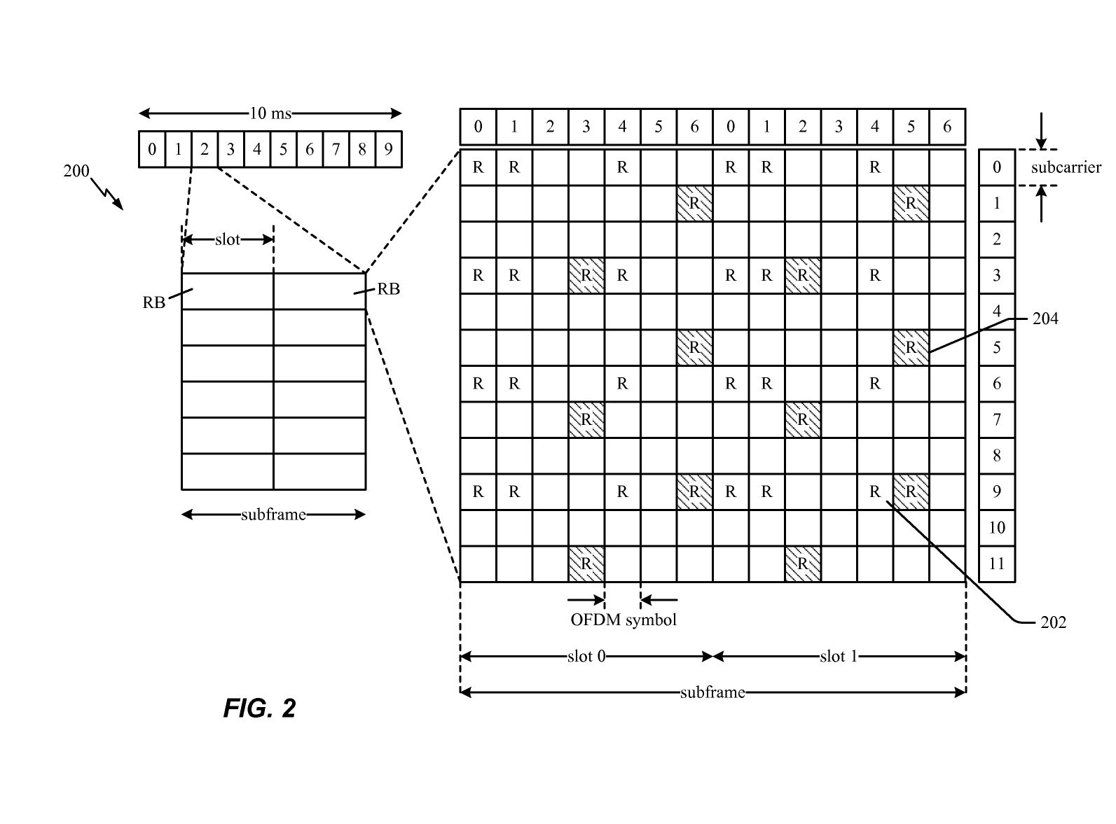

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204.

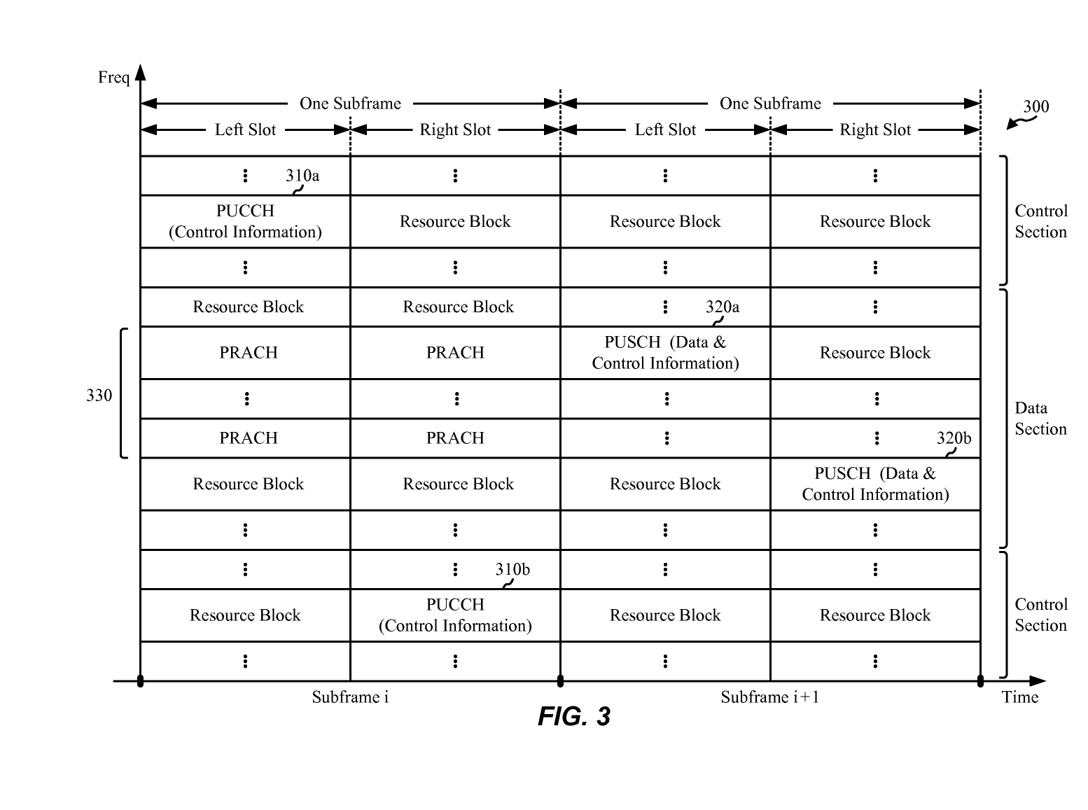

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. A set of resource blocks may be used to perform initial system access and achieve uplink synchronization in a physical random access channel (PRACH) 330.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

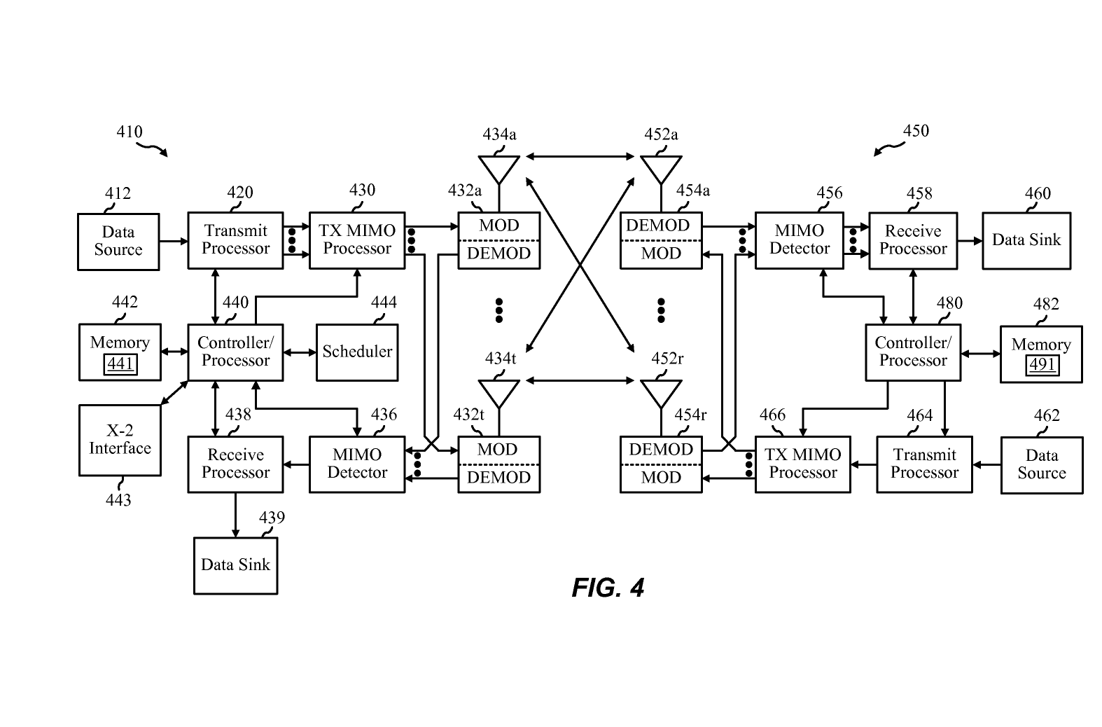

FIG. 4 is a block diagram of a base station (e.g., eNodeB or nodeB) 410 in communication with a UE 450 in an access network. In aspects implementing an LTE network, elements of the UE 450 illustrated in FIG. 4 may be used to implement the UE 102 and/or elements of the eNodeB 410 may be used to implement the eNodeB 106.

In the downlink, upper layer packets from the core network are provided to a controller/processor 480. The base station 410 may be equipped with antennas 434a through 434t, and the UE 450 may be equipped with antennas 452a through 452r.

At the base station 410, a transmit processor 420 may receive data from a data source 412 and control information from a controller/processor 440. The processor 420 may process (e.g., encode and symbol map) the data and control information to obtain data symbols and control symbols, respectively. The processor 420 may also generate reference symbols. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to produce an output sample stream. Each modulator 432 may further process (e.g., convert to analog, amplify, filter, and upconvert) the output sample stream to produce a downlink signal. Downlink signals from modulators 432a through 432t may be transmitted via the antennas 434a through 434t, respectively. These downlink signals may carry a downlink frame structure as illustrated in FIG. 2.

At the UE 450, the antennas 452a through 452r may receive the downlink signals from the base station 410 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 450 to a data sink 460, and provide decoded control information to a controller/processor 480.

On the uplink, at the UE 450, a transmit processor 464 may receive and process data (e.g., for the PUSCH) from a data source 462 and control information (e.g., for the PUCCH) from the controller/processor 480. The processor 464 may also generate reference symbols for a reference signal. The symbols from the transmit processor 464 may be precoded by a TX MIMO processor 466 if applicable, further processed by the modulators 454a through 454r (e.g., for SC-FDM, etc.), and transmitted to the base station 410 in uplink signals via the antennas 452a through 452r, respectively. These uplink signals may carry an uplink frame structure as illustrated in FIG. 3.

At the base station 410, the uplink signals from the UE 450 may be received by the antennas 434, processed by the demodulators 432, detected by a MIMO detector 436 if applicable, and further processed by a receive processor 438 to obtain decoded data and control information sent by the UE 450. The processor 438 may provide the decoded data to a data sink 439 and the decoded control information to the controller/processor 440. The base station 410 can send messages to other base stations, for example, over an X2 interface 443.

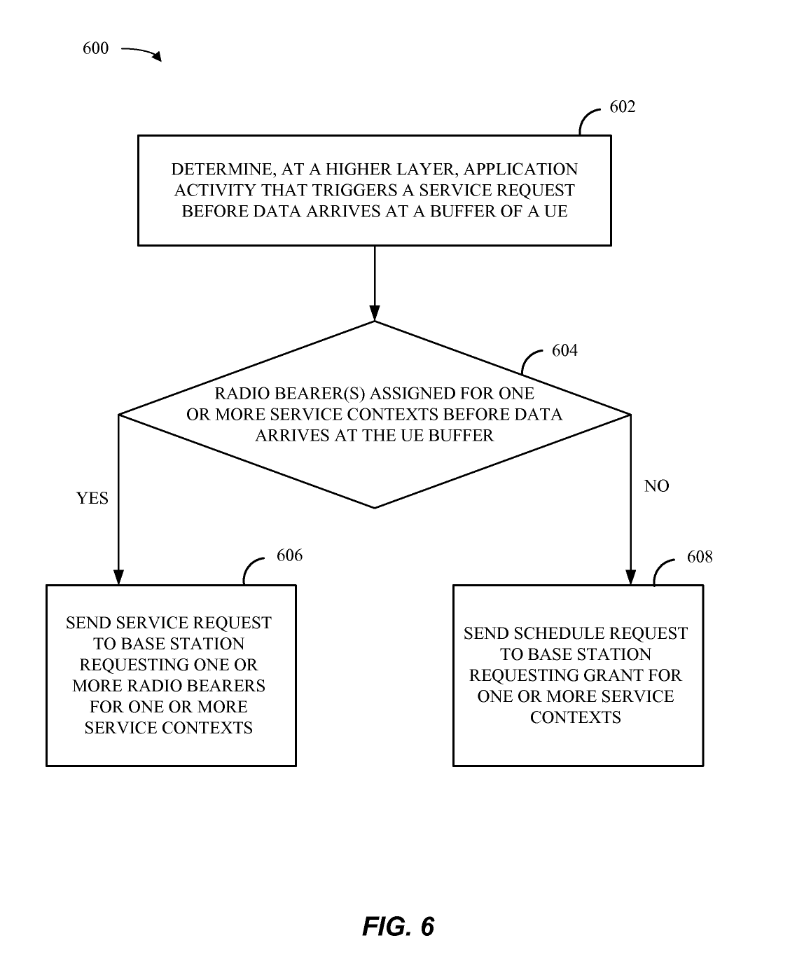

The controllers/processors 440 and 480 may direct the operation at the base station 410 and the UE 450, respectively. The processor 440/480 and/or other processors and modules at the base station 410/UE 450 may perform or direct the execution of functional blocks illustrated in FIGS. 6-12, and/or other processes for the techniques described herein. For example, the memory 482 of the UE 450 may store a service/schedule request module 491 which, when executed by the controller/processor 480, configures the UE 450 to send a service request/schedule request for radio communication resources according to one aspect of the present disclosure. While described herein as a single module, the service/schedule request module 491 may be implemented as a plurality of modules which, when executed by the controller/processor 480, configure the UE 450 to send a service request or to send a schedule request. The memory 442 of the base station 410 may store a radio communication resource module 441 which, when executed by the controller/processor 440, configures the base station 410 to provide communication resources for a UE 450 according to aspects of the present disclosure. The memories 442 and 482 may store data and program codes for the base station 410 and the UE 450, respectively. A scheduler 444 may schedule UEs for data transmission on the downlink and/or uplink.

In the uplink, the controller/processor 480 provides demultiplexing between transport and logical channels, packet reassembly, deciphering, header decompression, and control signal processing to recover upper layer packets from the UE 450. Upper layer packets from the controller/processor 480 may be provided to the core network. The controller/processor 480 is also responsible for error detection using an ACK and/or NACK protocol to support HARQ operations.

The descriptions above of a network, frame structure, UE, and base station are intended to serve only as examples of elements which may be used to implement certain functions and concepts that are further described below. In the descriptions below, several aspects of a telecommunications system will be presented with reference to LTE and GSM systems. As those skilled in the art will readily appreciate, however, various aspects described throughout this disclosure may be extended to other telecommunication systems, network architectures and communication standards, including 2G and 3G communication systems/architectures/standards, as well as those with high throughput and low latency such as 4G systems/architectures/standards, 5G systems/architectures/standards and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA or TD-SCDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

In a wireless telecommunication system, the communication protocol architecture may take on various forms depending on the particular application. For example, in a 3GPP UMTS system, the signaling protocol stack is divided into a non-access stratum (NAS) and an access stratum (AS). The NAS provides the upper layers, and may include circuit switched (GSM) and packet switched (e.g., LTE) protocols. The AS provides the lower layers, for signaling between the UTRAN and the UE, and may include a user plane and a control plane. The NAS layer is an upper layer for communicating with the core network, such as the MME (e.g., the MME 112) in an LTE network and a UE (e.g., the UE 102). Example functions include mobility management, such as location updates and session managements. The AS layer is for communicating between the eNodeB (in an LTE network, e.g., the eNodeB 106) and the UE (e.g., the UE 102). Example functions include random access, broadcasting system information, and radio connection setup, modification and release. From the network side, the AS layer and NAS layer are on different network nodes. From the UE side, the AS and NAS functions are provided in different layers. Here, the user plane or data plane carries user traffic, while the control plane carries control information (e.g., signaling).

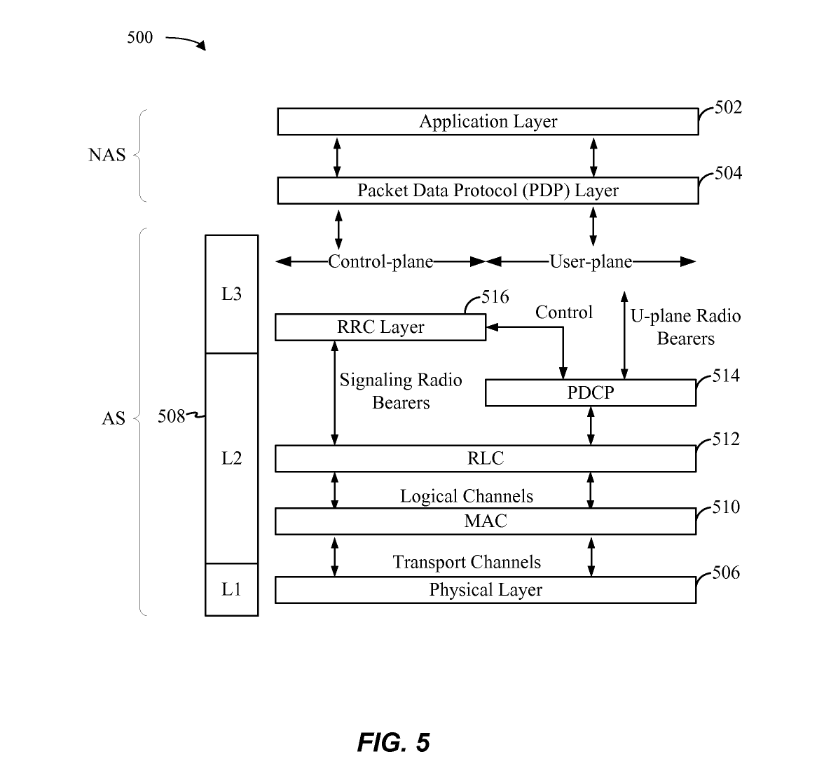

FIG. 5 is a conceptual diagram illustrating an example of a radio protocol architecture 500 for the user plane and the control plane. In aspects implementing an LTE network, the UE 102 and the nodes of the E-UTRAN 104 and/or EPC 110 may communicate using the radio protocol architecture 500.

The radio protocol architecture 500 is divided into a non-access stratum (NAS) and an access stratum (AS). The NAS includes an application layer 502 and a packet data protocol (PDP) layer 504. A packet data protocol may include internet protocol (IP) or point-to-point protocol (PPP). The application layer 502 is provided between a UE and a server. For example, for web browsing the application layer is HTTP on top of the TCP layer. The PDP layer 504 is provided between a component (e.g., node such as gateway general packet radio service support node) of a network and the UE.

The AS is shown with three layers: Layer 1, Layer 2, and Layer 3. Layer 1 is the lowest layer and implements various physical layer signal processing functions. Layer 1 will be referred to herein as the physical layer 506. The data link layer, (e.g., Layer 2 508), is above the physical layer 506 and is responsible for the link between the UE and NodeB over the physical layer 506.

At Layer 3, a radio resource control (RRC) layer 516 handles the control plane signaling between the UE and the NodeB. The RRC layer 516 includes a number of functional entities for routing higher layer messages, handling broadcasting and paging functions, establishing and configuring radio bearers, etc. The radio bearer may be a radio access bearer (RAB) or evolved universal terrestrial access network (E-UTRAN) radio bearer (eRB). For example, the RRC layer 516 functions as the overall controller of the access stratum, and configures all other layers in the access stratum. The RRC layer 516 also serves as the control and signaling interface to the non-access stratum.

Layer 2 508 is split into sublayers. In both the user plane and the control plane, Layer 2 508 includes two sublayers: a medium access control (MAC) sublayer 510 and a radio link control (RLC) sublayer 512. In the user plane, Layer 2 508 additionally includes a packet data convergence protocol (PDCP) sublayer 514. Although not shown, the UE may have several upper layers above Layer 2 508 including a network layer (e.g., IP layer) that is terminated at a packet data network (PDN) gateway on the network side and an application layer that is terminated at the other end of a connection (e.g., far end UE, server, etc.)

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between NodeBs. The PDCP also transfers user data that it receives in the form of PDCP service data units (SDUs) from the non-access stratum and forwards them to the RLC entity, and vice versa.

The RLC sublayer 512 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC sublayer 510. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

User equipments (UEs) can provide a multiplicity of services including both voice and data connections through wireless communication networks. A data connection between a mobile wireless communication device and an external data network, through a wireless communication network, can be considered “active” when the mobile wireless communication device is “attached” to the wireless communication network and when a “higher layer” service context is established.

A service context (e.g., radio bearer context or packet data protocol (PDP) context) indicates a number of communication settings that may be used by a UE during wireless communication. A service context may include such information as an internet protocol (IP) address, quality of service (QoS) indicators (such as latency requirements and/or throughput requirements), access point name (APN), access retention priority and other information. A UE may be associated with multiple service contexts during wireless communications. For example, each particular service on a UE (such as a game, email, VoIP, etc.) may have its own service context associated with certain communication settings (QoS, etc.) desired by the respective service.

Radio access network resources, such as the RABs or eRBs described above, can be used to transport packets between the UE and radio network subsystems in a radio access portion of the wireless communication network. For example, based on the service contexts, the network may determine which radio bearer is appropriate to service each service context. Based on the determined radio bearer, communication resources (such as time/frequency resource, Walsh code, etc.) are determined for each service context. Radio resources can be shared among multiple mobile wireless communication devices. However, with limited radio frequency bandwidth allocated for the radio access portion of the wireless communication network, the radio bearers can be released from the mobile wireless communication device and can be re-allocated when the data connection becomes idle, Because of the release and re-allocation of the radio resources, the LIE may increasingly have to request radio bearers for both active service contexts and new service contexts, which may delay communication between the UE and the network. Further, repetitive requests may increase the overhead within the network.

For example, with the service context active, higher layer processes in the UE can continue to send data packets to lower layer processes for transmission to the wireless communication network. However, without radio resources allocated by the wireless communication network, the data packets can accumulate in a pending data buffer. Each new data packet in the pending data buffer can trigger the service request at the lower layer from the UE to a radio network subsystem (RNS) (such as the EUTRAN 104 of FIG. 1) in the wireless communication network for the radio resources. For example, the service request for radio resources is sent at the lower layer of a protocol stack for data packets in the buffer that are to be scheduled for transmission. The schedule request for transmitting the data packets are sent in response to receiving the data packets at the buffer. Sending of the service request in this way, e.g., at the lower layer of a protocol stack, may delay communication between the UE and the network. Similarly, delaying scheduling requests for the transmission of the data packets until the data packet is received at the UE buffer may add to delays in communication between the UE and the network.

Further, the service contexts for a UE may be preserved while in idle mode and during inter-radio access technology (IRAT) transition/handover. For example, the service context can remain active, even though radio resources are released or re-allocated. When the UE moves to a dedicated channel (DCH) or other radio access technology (RAT), a UE may include data status information for each service context associated with the UE in the service request message for a data call. Uplink data status information may indicate which preserved service contexts are associated with pending uplink data to be sent. For example, when application data is created and arrives into the UE buffer, the UE sends its uplink data status (e.g., with a true flag) to the network indicating that certain service contexts have or are associated with data at the UE buffer to send but not others. The network then configures radio bearers for the service contexts (e.g., one RAB to service context in one service request). In this situation, repetitive requests for active service contexts and new service contexts may also be transmitted, which may cause delayed communications and/or increased overhead as described above.

### Examples of Service Request, Scheduling Request, and Allocation of Radio Resources for Service Contexts

Aspects of the present disclosure are directed to service requests for radio resources for service contexts and scheduling requests for the service contexts. In some aspects, transmission of such service requests and/or scheduling requests reduces communication delays and/or network congestion. In several aspects, when a UE (for example the UE 102 and/or 450) determines, at a higher layer (e.g., a layer in the NAS of the radio protocol architecture 500), that an activity (e.g., application activity) will trigger a service request for the radio resources for a service request associated with an expected data packet, the UE sends the service request at the higher layer prior to the data packet arriving or being generated at a lower layer (e.g., a layer in the AS of the radio protocol architecture 500). For example, when a user clicks on an icon for a picture, the UE is aware that data associated with the picture is expected to arrive at the UE buffer (at a lower layer than an application layer). The higher layer may be a non-access stratum (NAS) layer such as an application layer. The lower layer may be an access stratum layer such as a medium access control (MAC) layer or a physical layer.

The activity may include a user clicking on a web link at the higher layer on the UE or the network receiving an indication of the click on the web link and the UE or the network expecting corresponding data to subsequently arrive at a buffer of the UE or a buffer of a network in response to the click. The activity may also include a user clicking on a picture (e.g., a thumbnail or a picture indication) and expecting a picture to arrive at the buffer of the UE.

In response to the determination, the UE sends the service request to a base station to request one or more radio bearers for the service context(s) (e.g., packet data protocol (PDP) context(s)) corresponding to the expected data when there are no existing radio bearers for the one or more service context. For example, the NAS layer of the UE sends the service request for one or more service contexts (e.g., active and/or inactive service contexts) in advance of the arrival of the data packet, at the lower layer in response to the determination. In some instances, the UE may indicate that inactive service contexts are active even though there is no data in the UE buffer corresponding to the inactive service context. In response to the service request, the UE receives a single radio bearer setup for setting up a first radio bearer for a first service context associated with a first service (e.g., clicking on the web link), and a second radio bearer for a second service context associated with a separate service (e.g., receiving expected corresponding data.) The UE then transmits data over channels corresponding to the first radio bearer and the second radio bearer from the buffer of the UE.

The UE may indicate that the inactive service contexts (without uplink (UL) data in the UE buffer) are active to cause the network to use a radio resource control (RRC) message to configure radio access bearers (RABs) for all service contexts. For example, the network uses an RRC message to configure RABs for service contexts, which already have data, will have or expect to have data at the UE buffer in the future. Thus, the UE does not have to wait for the expected data to arrive at the UE buffer before the service requests based on data arrival are sent to the network.

Alternatively, in response to the determination, when one or more radio bearers are already assigned before the data packet corresponding to the assigned radio bearer(s) arrives at the buffer of the UE, the UE sends a schedule request from a lower layer (for example, a medium access control layer generates a request and sends it to a physical layer, which then sends the schedule request to the base station through the air interface) for a grant (e.g., uplink (UL) grant) for the service context. In this aspect, the schedule request for the service context is sent prior to the data packet arriving at the UE buffer. For example, the UE sends the schedule request in response to determining that the application activity that triggers the service request for the radio resources for the expected data packet. The schedule request may include a status report for the UE buffer. For example, the buffer status report may indicate an expected data volume for each radio bearer.

In one aspect of the disclosure, an indication from the higher layer (application layer) to the lower layer (e.g., access stratum layer) triggers sending of the service request from the lower layer for the radio bearer for one or more service context when radio bearers for the one or more service context are not assigned. Similarly, an indication (e.g., a flag) from the higher layer to the lower layer triggers sending of the scheduling request for the service context from the lower layer when the radio bearer for the one or more service context are already assigned. Thus, latency may be reduced by identifying expected data at the higher layer and sending the service request or the schedule request on behalf of the expected data identified at the higher layer, rather than waiting for arrival of the data at the lower layer.

In another aspect of the disclosure, the application activity indicates that the uplink data is expected to arrive at the UE buffer, thereby causing the service request or the schedule request to be sent before the uplink data is generated and arrives at the UE buffer. For example, the data (e.g., uplink data) may be generated by an application processor (e.g., the controller/processor 480 of FIG. 4) and the data may arrive at a buffer of a modem. In a further aspect of the disclosure, the UE determines whether to send the service request for radio bearers for the service context or whether to send a schedule request for the service context before the uplink data is generated or arrives at the UE buffer based on an application latency specification. The application latency specification corresponds to latency specification for an application running on the UE. For example, in LTE, the latency specification is defined on the RAB. In 2G/3G networks, the latency specification is defined in the PDP context.

In yet another aspect of the disclosure, a UE determines that a data activity relationship exists between a first service context and a second service context. The data activity relationship may exist such that the arrival of data at the UE buffer for a first application (corresponding to the first service context) indicates that data is expected to arrive for a second application (corresponding to the second service context). When the UE determines that the data activity relationship exists, the UE sends a service request for the first service context and the second service context requesting radio bearers for both service contexts or sends a schedule request for both service contexts when radio bearers are already assigned (e.g., for the first service context and/or the second service context). For example, when there is internet protocol multimedia subsystem (IMS) data for signaling bearer or service context for voice over LTE, voice data is expected for data bearer or context.

For example, when the data activity relationship exists, the first application has uplink data activity, and there is an expected uplink data activity for the second application, the UE sends the service request for the first service context and the second service context requesting radio bearers for both service contexts based on the data activity relationship. Data activity (e.g., uplink data activity) may include an arrival of data at the buffer of the UE.

Alternatively, when radio bearers are already assigned, the UE sends a single schedule request for both the first service context and the second service context when the data activity relationship exists. Similar to the implementation for the service request, the UE sends the schedule request for the first service context and the second service context requesting the radio bearers for both service contexts when the first application has uplink data activity and there is expected uplink data activity for the second application.

In some aspects, the UE sends a service request or schedule request for both applications (e.g., first service context and second service context of the applications) only when a time window between the first application data activity and the expected data activity for the second application is below a threshold or shorter than the threshold (e.g., time threshold). The threshold may be defined by the UE. For example, data activity (e.g., application data activity) may include an arrival of data at the buffer of the UE. The UE sends a service request or schedule request only for a first application corresponding to the first service context when a time window between the first application data activity and the expected data activity for the second application is longer than the threshold.

In a further aspect of the disclosure, the UE determines whether to send the service request for the second application concurrently with the first application based on a latency specification of the second application. Afterwards, a grant is received. Data can then be transmitted using the grant.

In another example, a base station or network receives a service request for a first service context and determines a relationship between the first service context and a second service context of a UE based on a downlink data activity relationship. For example, the downlink data activity relationship may exist such that the arrival of data at the UE buffer for a first application (corresponding to the first service context) indicates that data is expected to arrive for a second application (corresponding to the second service context). The data activity relationship may be determined by the network or indicated to the network (by a UE, for example). The base station then sends a radio bearer setup for the first service context and the second service context based on the relationship between the first service context and the second service context. Thus, the base station sends the radio bearer setup for the second service context without receiving a service request for the second service context.

In a further aspect of the disclosure, a base station or network receives a schedule request for a first service context and determines a relationship between the first service context and a second service context based on a downlink data activity relationship. As noted, the downlink data activity relationship may exist such that the arrival of data at the UE buffer for a first application (corresponding to the first service context) indicates that data is expected to arrive for a second application (corresponding to the second service context). For example, if base station knows first data arrives at t=1 second, the base station may expect the second data to arrive at t=2 seconds based on a previous behavior stored in a history of timing differences.

The base station determines a grant size for the first service context and the second service context. For example, the grant size may be a transport block size based on radio resource allocated, modulation scheme and coding rate. The grant size can be based on an actual data size for the first service context plus an expected data size for the second service context. The base station then sends one or more grants (e.g., uplink grant and/or downlink grant) for the first service context and the second service context based on the relationship between the first service context and the second service context. Thus, the base station sends the downlink grant for the second service context without receiving a schedule request for the second service context.

Furthermore, the base station determines a grant size for a first radio bearer (e.g., a radio bearer grant size) and a second radio bearer and sends the grant (e.g., downlink grant) for the first radio bearer corresponding to the first service context and the second radio bearer corresponding to the second service context based on a time interval between the downlink grant and a downlink high speed shared data transmission. In addition, the base station determines a grant size for the first service context and the second service context and sends the grant (e.g., downlink grant, second grant) for the first service context and the second service context based on a time interval between data arrival in a first radio bearer and expected data arrival in a second radio bearer. For example, when voice frames of a video telephone call arrive on a first radio bearer for voice, video frames are expected to arrive on a subsequent radio bearer (e.g., second radio bearer) for video.

### DESCRIPTION OF CERTAIN METHODS

FIG. 6 is a flow diagram 600 illustrating an example method for sending a service request for radio resources for a service context or a schedule request for the service context according to aspects of the present disclosure. The method may in some embodiments reduce communication delays associated with service requests for radio resources for service contexts and/or scheduling requests for the service contexts. The method starts with a user equipment (UE) determining, at a higher layer (e.g., application layer), application activity that triggers a service request before data arrives at the UE buffer (e.g., in the memory 482), at block 602. For example, the controller/processor 480 of the UE 450 of FIG. 4 determines the application activity, for example at the application layer. An application activity, such as clicking on a link, indicator or thumbnail for a picture, for example, as described in more detail above in the Examples of Service Request, Scheduling Request, and Allocation of Radio Resources for Service Contexts section (referred to hereinafter as the “Examples section”), triggers a download of a picture at the UE buffer. Thus, in response to the click, the UE expects data associated with the picture to arrive at the buffer of the UE.

The UE determines whether radio bearer(s) have been assigned for one or more service contexts associated with the expected data, at block 604. The UE knows the radio bearer has been assigned from the signaling bearer setup message, received from the network. For example, the controller/processor 480 of FIG. 4 determines whether the radio bearer(s) have been assigned. When the radio bearer(s) have been assigned for the one or more service contexts before data arrives at the UE buffer, the method continues to block 606. At block 606, in response to determining the application activity and determining that the radio bearer(s) has been assigned, the UE sends a service request to a base station, for example, as described in more detail above in the Examples section, requesting one or more radio bearers for the one or more service contexts. For example, the controller/processor 480 and/or the transmit processor 464 of the UE 450 in conjunction with antenna 452 sends the service request to the base station 410 of FIG. 4. Otherwise, when the radio bearer(s) has not been assigned for the one or more service contexts before data arrives at the UE buffer, the method continues to block 608. At block 608, in response to determining the application activity and determining that the radio bearer(s) has not been assigned, the UE sends a schedule request to a base station requesting a grant (e.g., uplink (UL) grant) for the one or more service contexts. Similar to the service request, the controller/processor 480 and/or the transmit processor 464, and the service/schedule request module 491 of the UE 450 in conjunction with antenna 452 sends the schedule request to the base station 410 of FIG. 4.

Aspects of the present disclosure may improve performance and user perception by reducing latency. Additionally, over the air message overhead, network and UE processing load and UE battery power consumption may be reduced.

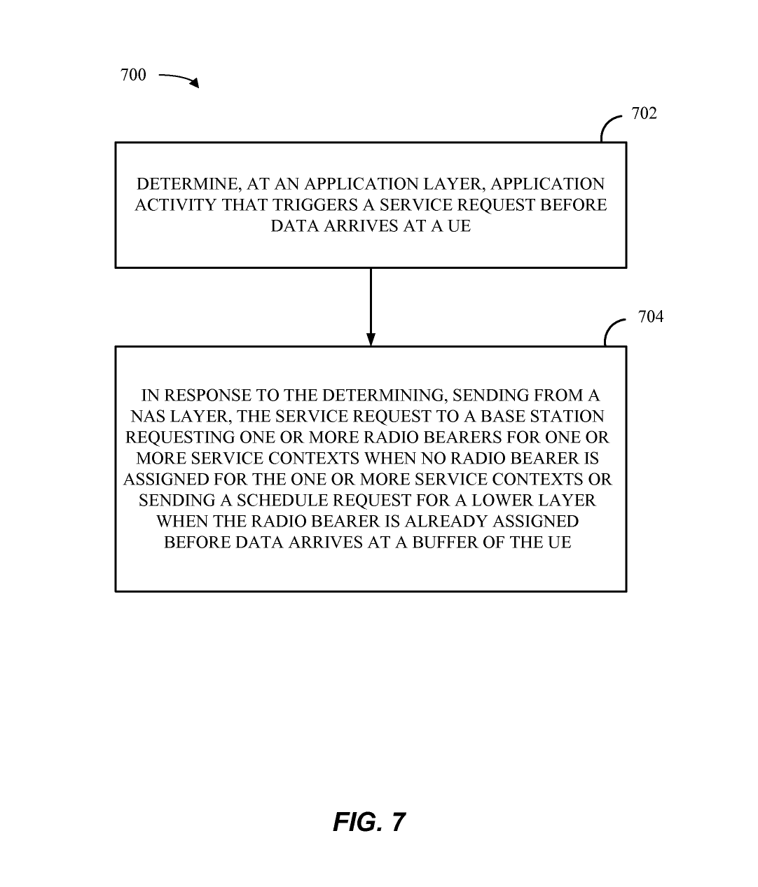

FIG. 7 is a flow diagram 700 illustrating an example method at a user equipment (UE) according to aspects of the present disclosure. The method may reduce communication delays associated with service requests for radio resources for service contexts and scheduling requests for the service contexts. When the UE determines, at a higher layer (e.g., non-access stratum (NAS) layer), that an activity (e.g., application activity) that triggers a service request for the radio resources for a service request associated with expected data packet, the UE sends the service request at the higher layer prior to the data packet arriving or being generated at a lower layer. For example, at block 702, the UE determines, at an application layer, the application activity that triggers the service request before data arrives at the buffer of the UE. The determination at the application layer may be made by the controller/processor 480 of the UE 450 of FIG. 4. At block 704, in response to the determining, the UE sends, from a lower layer (e.g., access stratum (AS) layer), the service request to a base station requesting one or more radio bearers for one or more service contexts when no radio bearer is assigned for the one or more service contexts. Alternatively, the UE sends a schedule request from a lower layer (e.g., physical layer (PHY) or medium access control (MAC) layer) when the radio bearer is already assigned before data arrives at the buffer of the UE. The sending of the service request and/or the schedule request to the base station (e.g., base station 410) may be performed by the controller/processor 480 and/or the transmit processor 464 of the UE 450 in conjunction with the antenna 452.

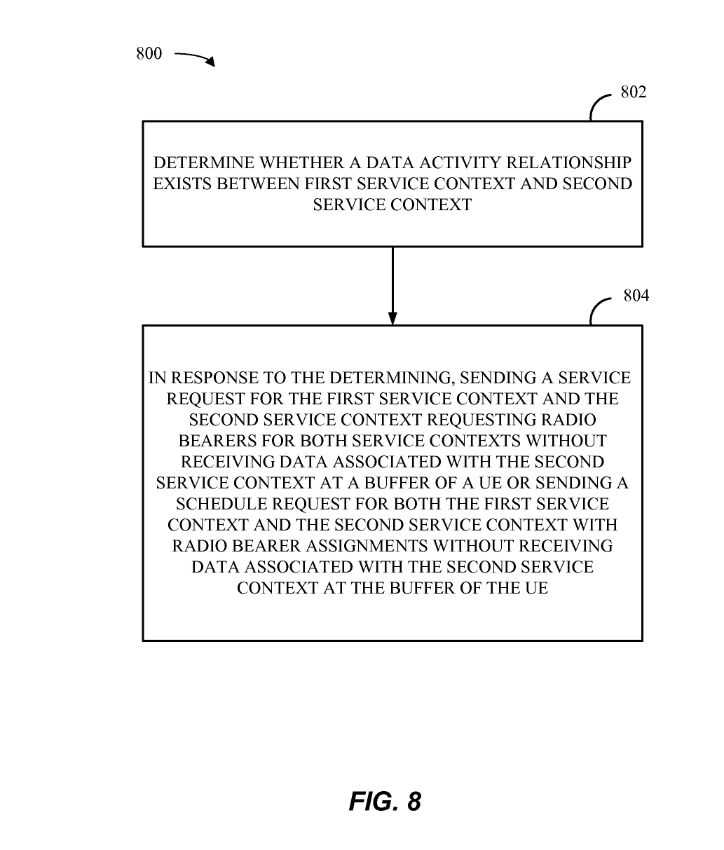

FIG. 8 is a flow diagram 800 illustrating an example method at a user equipment (UE) according to aspects of the present disclosure. The method of FIG. 8 may reduce communication delays associated with service requests for radio resources for service contexts and scheduling requests for the service contexts. In this example, the UE sends a service request for a first service context and a second service context requesting radio bearers for both service contexts when the UE determines that a data activity relationship exists between the first service context and a second service context, for example as described in more detail above in the Examples section. Similarly the UE sends a schedule request for both service contexts when radio bearers are already assigned (e.g., for the first service context and/or the second service context) when the UE determines that a data activity relationship exists between the first service context and a second service context, for example as described in more detail above in the Examples section. For example, at block 802, the controller/processor 480 of the UE 450 of FIG. 4 determines whether a data activity relationship exists between a first service context and a second service context. The controller/processor 480 may use any of the techniques described above in the Examples section, At block 804, when the relationship exists, the controller/processor 480 and/or the transmit processor 464 of the UE 450 in conjunction with the antenna 452 sends a service request for the first service context and the second service context requesting radio bearers for both service contexts or sends a schedule request for both the first service context and the second service context with radio bearer assignments.

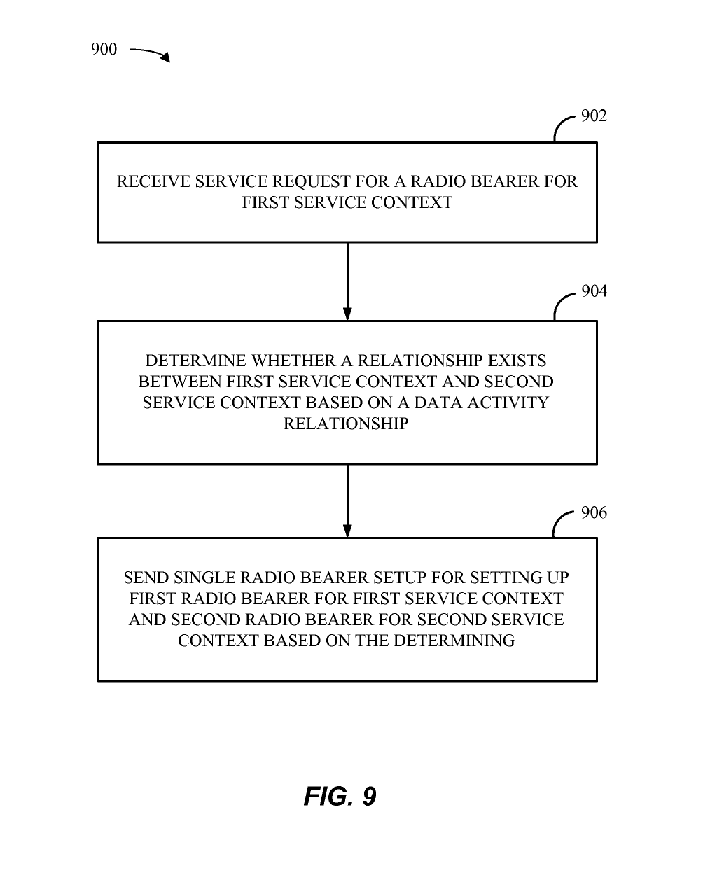

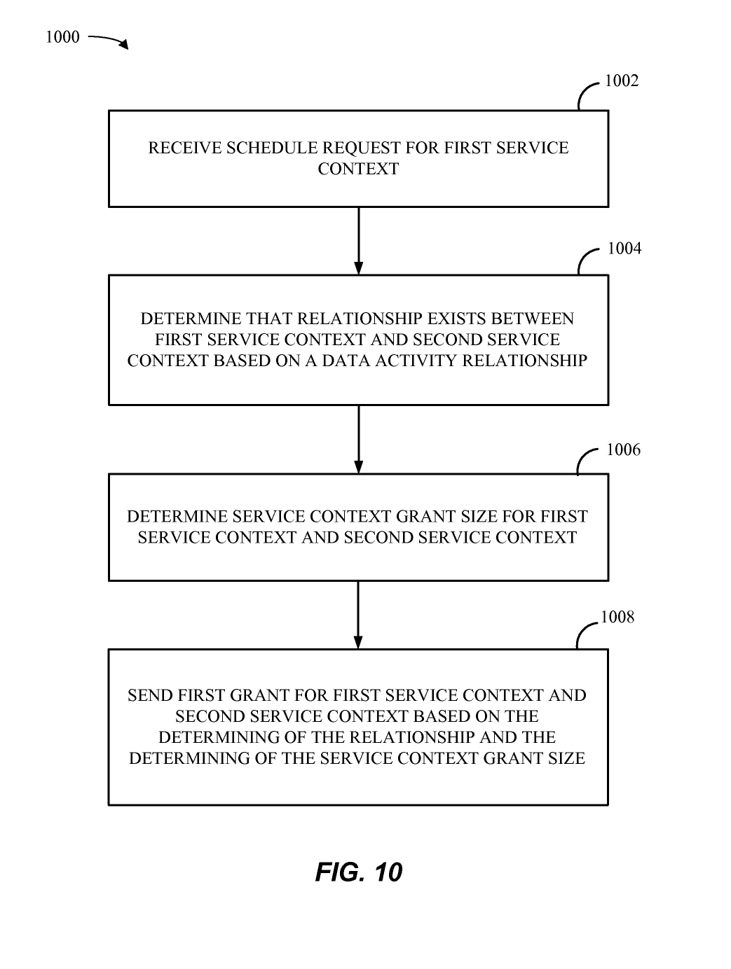

Similar, to the methods of FIGS. 6-8, the methods of FIGS. 9-10 may reduce communication delays associated with service requests for radio resources for service contexts and scheduling requests for the service contexts. However, the methods of FIGS. 9 and 10 are implemented at a base station, such as the base station 410 of FIG. 4.

For example, FIG. 9 is a flow diagram 900 illustrating an example method at a base station according to aspects of the present disclosure. According to the method of FIG. 9, the base station or network receives a service request for a first service context and determines a relationship between the first service context and a second service context based on a data activity (e.g., downlink data activity) relationship, for example as described in more detail above in the Examples section. For example, at block 902, the controller/processor 440 and/or the receive processor 438 in conjunction with the antenna 434 of the base station 410 receives a service request for a first service context. At block 904, the controller/processor 440 of the base station 410 determines that a relationship exists between the first service context and a second service context based on the data activity relationship. At block 906, the controller/processor 440 and/or the transmit processor 420 in conjunction with the antenna 434 and the radio communication resource module 441 of the base station 410 sends a single radio bearer setup for setting up a first radio bearer for the first service context and a second radio bearer for the second service context based on the determining.

Similar to FIG. 9, FIG. 10 is a flow diagram 1000 illustrating an example method at a base station according to aspects of the present disclosure. However, the method of FIG. 9 sends one or more grants (e.g., uplink grant and/or downlink grant) for the first service context and the second service context based on the relationship between the first service context and the second service context in response to receiving a schedule request for a first service context, for example as described in more detail above in the Examples section. For example, at block 1002, the controller/processor 440 and/or the receive processor 438 in conjunction with the antenna 434 of the base station receives a schedule request for a first service context. At block 1004, the controller/processor 440 of the base station 410 determines that a relationship exists between the first service context and a second service context based on a data activity (e.g., downlink data activity) relationship. At block 1006, the controller/processor 440 of the base station 410 determines a service context grant size for the first service context and the second service context, for example as described in more detail above in the Examples section. At block 1008, the controller/processor 440 and/or the transmit processor 420 in conjunction with the antenna 434 of the base station 410 sends a first grant for the first service context and the second service context based on the determining of the relationship and the determining of the service context grant size.

### Description of Certain Apparatus

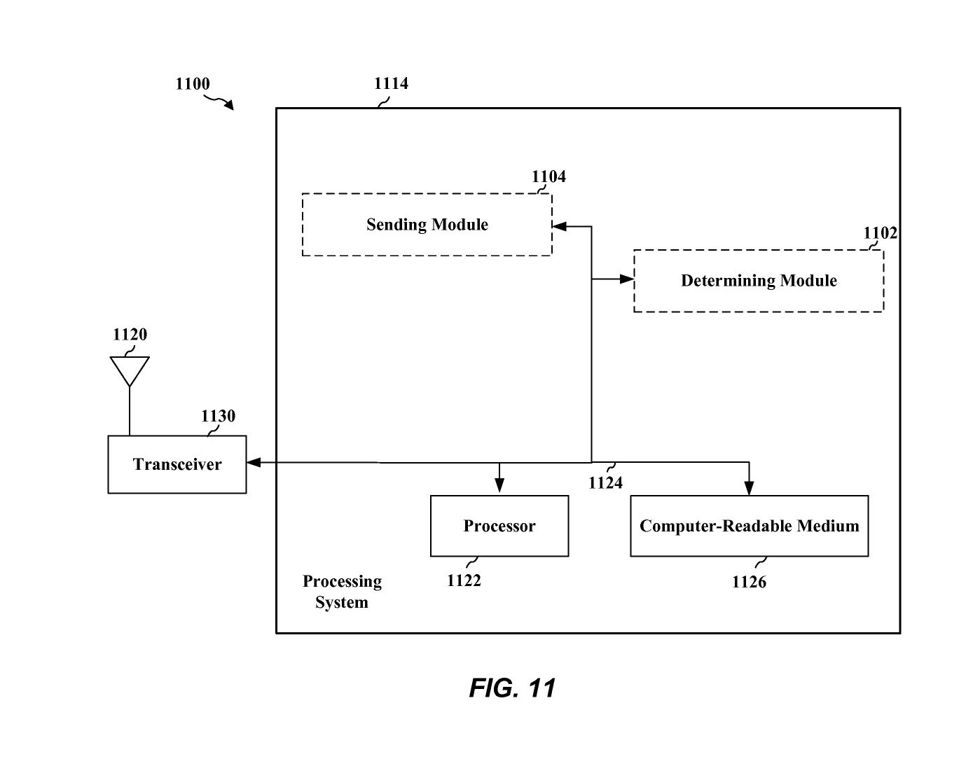

FIG. 11 is a diagram illustrating an example of a hardware implementation for an apparatus 1100 employing a processing system 1114 according to one aspect of the present disclosure. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122, a determining module 1102, a sending module 1104, and the non-transitory computer-readable medium 1126. The bus 1124 may also link various other circuits such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a non-transitory computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes a determining module 1102 for determining, at an application layer, application activity that triggers a service request before data arrives at a buffer of the UE. The determining module 1102 may also determine whether a data activity relationship exists between a first service context and a second service context. The processing system also includes a sending module 1104 for sending, in response to the determining of the application activity, from a lower layer (e.g., access stratum (AS) layer), the service request to a base station requesting one or more radio bearers for one or more service contexts when no radio bearer exists for the one or more service contexts. The sending module 1104 may also send, when the relationship exists, a service request for the first service context and the second service context requesting radio bearers for both service contexts or send a schedule request for both the first service context and the second service context with radio bearer assignments. The determining module 1102 and/or the sending module 1104 may be software module(s) running in the processor 1122, resident/stored in the computer-readable medium 1126, one or more hardware modules coupled to the processor 1122, or some combination thereof. For example, when the determining module 1102 is a hardware module, the determining module 1102 may include the controller/processor 480. When the sending module 1104 is a hardware module, the sending module 1104 may include the controller/processor 480 and/or the transmit processor 464 in conjunction with the antenna 452. The processing system 1114 may be a component of the UE 450 of FIG. 4 and may include the memory 482, and/or the controller/processor 480.

In one configuration, an apparatus such as a UE 450 is configured for wireless communication including means for determining. In one aspect, the determining means may be the controller/processor 480 of FIG. 4, the memory 482 of FIG. 4, the service/schedule request module 491 of FIG. 4, the determining module 1102 of FIG. 11, the processor 1122 of FIG. 11 and/or the processing system 1114 of FIG. 11 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 450 is configured for wireless communication including means for sending. In one aspect, the sending means may be the antenna 452 of FIG. 4, the antenna 1120 of FIG. 11, transceiver 1130 of FIG. 11, transmit MIMO processor 466 of FIG. 4, transmit processor 464 of FIG. 4, controller/processor 480 of FIG. 4, the memory 482 of FIG. 4, the service/schedule request module 491 of FIG. 4, the sending module 1104 of FIG. 11, and/or the processing system 1114 of FIG. 11 configured to perform the aforementioned means. In one configuration, the means functions correspond to the aforementioned structures. In another aspect, the aforementioned means may be a module or any apparatus configured to perform the functions recited by the aforementioned means.

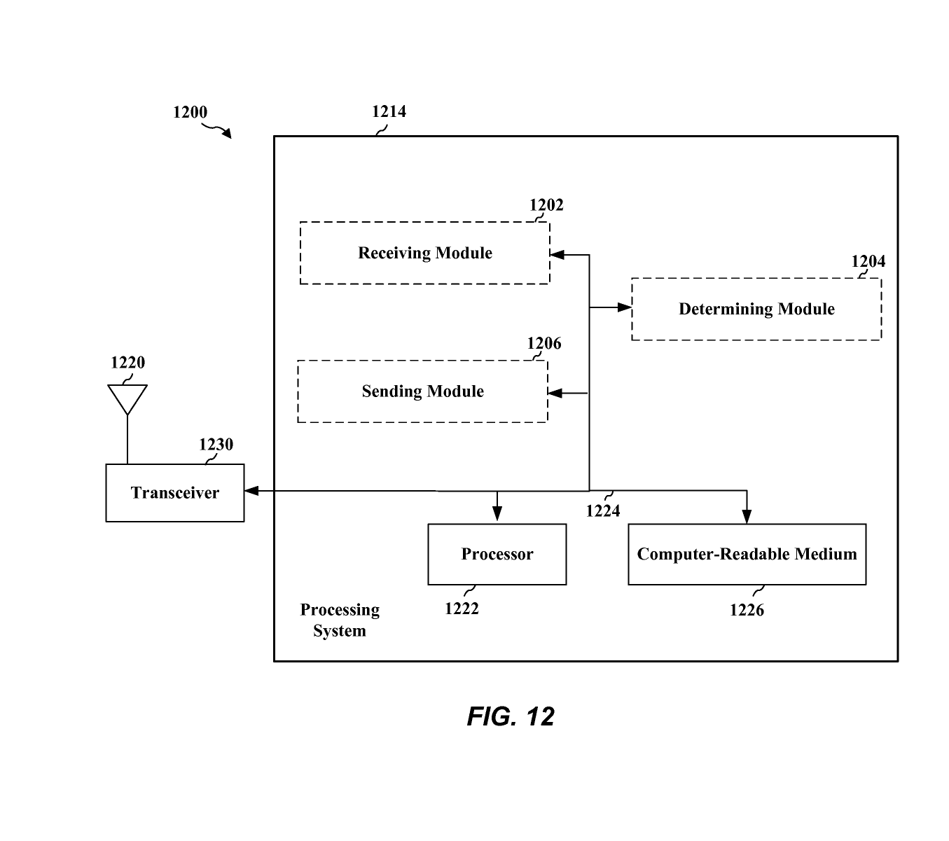

FIG. 12 is a diagram illustrating an example of a hardware implementation for an apparatus 1200 employing a processing system 1214 according to one aspect of the present disclosure. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222, a receiving module, 1202, a determining module 1204, a sending module 1206, and the non-transitory computer-readable medium 1226. The bus 1224 may also link various other circuits such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatus over a transmission medium. The processing system 1214 includes a processor 1222 coupled to a non-transitory computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a receiving module 1202 for receiving a service or schedule request for a first service context. The processing system 1214 also includes a determining module 1204 for determining whether a relationship exists between the first service context and a second service context based on a data activity relationship. The determining module 1204 also determines a grant size for the first service context and the second service context. The processing system further includes a sending module 1206 for sending a single radio bearer setup for setting up a first radio bearer for the first service context and a second radio bearer for the second service context based on the determining. The sending module 1206 may also send a [downlink (DL), uplink (UL) or both] grant for the first service context and the second service context based on the determining of the relationship and the determining of the service context grant size. The receiving module 1202, determining module 1204 and/or the sending module 1206 may be software module(s) running in the processor 1222, resident/stored in the computer-readable medium 1226, one or more hardware modules coupled to the processor 1222, or some combination thereof. For example, when the receiving module 1202 is a hardware module, the receiving module may include the controller/processor 440 and/or the receive processor 438 in conjunction with the antenna 434. When the determining module 1204 is a hardware module, the determining module may include the controller/processor 440. When the sending module 1206 is a hardware module, the sending module 1206 may include the transmit processor 420 in conjunction with the antenna 434. The processing system 1214 may be a component of the base station 410 of FIG. 4 and may include the memory 442, and/or the controller/processor 440.

In one configuration, an apparatus such as a base station 410 is configured for wireless communication including means for receiving. In one aspect, the receiving means may be the antenna 434 of FIG. 4, antenna 1220 of FIG. 12, transceiver 1230 of FIG. 12, modulator/demodulator 432 of FIG. 4, MIMO detector 436 of FIG. 4, receive processor 438 of FIG. 4, controller/processor 440 of FIG. 4, the memory 442 of FIG. 4, the radio communication resource module 441 of FIG. 4, the receiving module 1202 of FIG. 12, and/or the processing system 1214 of FIG. 12 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a base station 410 is configured for wireless communication including means for determining. In one aspect, the determining means may be the controller/processor 440 of FIG. 4, the memory 442 of FIG. 4, the radio communication resource module 441 of FIG. 4, the determining module 1204, the processor 1222 of FIG. 12 and/or the processing system 1214 of FIG. 12 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a base station 410 is configured for wireless communication including means for sending. In one aspect, the sending means may be the antenna 434 of FIG. 4, antenna 1220 of FIG. 12, transceiver 1230 of FIG. 12, transmit MIMO processor 430 of FIG. 4, transmit processor 420 of FIG. 4, controller/processor 440 of FIG. 4, the memory 442 of FIG. 4, the radio communication resource module 441 of FIG. 4, the sending module 1206 of FIG. 12, and/or the processing system 1214 of FIG. 12 configured to perform the aforementioned means. In one configuration, the means functions correspond to the aforementioned structures. In another aspect, the aforementioned means may be a module or any apparatus configured to perform the functions recited by the aforementioned means.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining, at an application layer, an application activity that triggers a service request before data arrives at a buffer of a UE (user equipment); and
in response to the determining, either sending, from a NAS layer (non-access stratum layer), the service request to a base station requesting at least one radio bearer for at least one service context when no radio bearer is assigned for the at least one service context or sending a schedule request from a lower layer than the NAS layer when the radio bearer is already assigned before data arrives at the buffer of the UE.

2. The method of claim 1, in which the application activity indicates that uplink data (UL data) is expected to arrive at the buffer of the UE, and the service request or the schedule request is sent before the uplink data is generated or arrives at the buffer of the UE.

3. The method of claim 2, further comprising determining whether to send the service request to the base station requesting at least one radio bearer or to send the schedule request before the uplink data is generated or arrives at the buffer of the UE based at least in part on latency specifications for an application.

4. The method of claim 1, further comprising sending the schedule request with radio bearer assignment in response to an indication from the application layer.

5. The method of claim 1, further comprising sending the service request in response to an indication from the application layer.

6. The method of claim 1, in which the determining comprises determining that data arrives at the application layer or that user interface input is received.

7. A method of wireless communication, comprising:
receiving a service request for at least one radio bearer for a first service context;
determining whether a relationship exists between the first service context and a second service context based at least in part on a data activity relationship; and
sending a single radio bearer setup for setting up a first radio bearer for the first service context and a second radio bearer for the second service context based at least in part on the determining.

8. The method of claim 7, further comprising determining the data activity relationship based at least in part on a history of data arrival timing differences.

9. The method of claim 7, further comprising receiving an indication from a UE (user equipment) indicating the data activity relationship.

10. The method of claim 7, in which the data activity relationship comprises a downlink data activity relationship.

11. A method of wireless communication, comprising:
receiving a schedule request for a first service context;
determining a relationship exists between the first service context and a second service context based at least in part on a data activity relationship;
determining a service context grant size for the first service context and the second service context; and
sending a first grant for both the first service context and the second service context based at least in part on the determining the relationship and the determining the service context grant size.

12. The method of claim 11, further comprising determining a radio bearer grant size for a first radio bearer and a second radio bearer and sending a second grant for the first radio bearer and the second radio bearer based at least in part on a time interval between the second grant and a high speed shared data transmission.

13. The method of claim 11, further comprising sending the first grant for the first service context and the second service context based at least in part on a time interval between data arrival in a first radio bearer and expected data arrival in a second radio bearer.

14. The method of claim 11, in which the service context grant size is based at least in part on an actual data size for the first service context plus an expected data size for the second service context.

15. An apparatus for wireless communication, comprising:
a memory;
a transceiver configured for wireless communication; and
at least one processor coupled to the memory and the transceiver, the at least one processor configured:
to determine, at an application layer, an application activity that triggers a service request before data arrives at a buffer of a UE (user equipment); and
in response to the determining, to either send, from a NAS layer (non-access stratum layer), the service request to a base station requesting at least one radio bearer for at least one service context when no radio bearer is assigned for the at least one service context or to send a schedule request from a lower layer than the NAS layer when the radio bearer is already assigned before data arrives at the buffer of the UE.

16. The apparatus of claim 15, in which the application activity indicates that uplink data (UL data) is expected to arrive at the buffer of the UE, and in which the at least one processor is further configured to send the service request or the schedule request before the uplink data is generated or arrives at the buffer of the UE.

17. The apparatus of claim 16, in which the at least one processor is further configured to determine whether to send the service request or to send the schedule request before the uplink data is generated or arrives at the buffer of the UE based at least in part on latency specifications for an application.

18. The apparatus of claim 15, in which the at least one processor is further configured to send the schedule request with radio bearer assignment in response to an indication from the application layer.

19. The apparatus of claim 15, in which the at least one processor is further configured to send the service request in response to an indication from the application layer.

20. The apparatus of claim 15, in which the at least one processor is further configured to determine that data arrives at the application layer or that user interface input is received.
